(19) United States
(12) Patent Application Publication
(10) Pub. No.: US 2013/0181571 A1
(43) Pub. Date: Jul. 18, 2013

(54) Structure for Electrical Machines

(71) Applicant: HSIU-MEI CHANG, New Taipei City (TW)

(72) Inventor: HSIU-MEI CHANG, New Taipei City (TW)

(21) Appl. No.: 13/351,226

(22) Filed: Jan. 17, 2012

(51) Int. Cl. H02K 1/18; H02K 1/00

(52) U.S. Cl. 310/216.137; 310/216.001; 310/216.113

(57) ABSTRACT

An improved structure for electrical machines generally comprises a plurality of stator modules, a supporting member, and at least one outer rotor. The stator modules are interconnected to form a stator core and define a total of seventy-two slots. The supporting member is fixedly mounted with the stator modules at a circumference thereof. The outer rotor is provided with a plurality of magnetic members for magnetically interaction with the stator modules. Thereby, the stator core thereof can be fabricated in a modularized way, so that the disadvantage of having to cut out a large central part of a stator core, as in conventional structures, can be overcome; moreover, the stator core thereof can cooperate with a rotor that employs iron-oxides magnets, to achieve a high power output and to increase the good rate of product.

### TECHNICAL FIELD OF THE INVENTION

The present invention relates to an improved structure for electrical machines, and more particularly to a structure that the stator core thereof is fabricated in modularized way, so that the manufacturing cost can be reduced.

### DESCRIPTION OF THE PRIOR ART

Brushless permanent magnet (BLPM) motors have been widely applied in various fields, such as air conditioners, fans, sports equipment, computers, printers, photocopying machines, vehicles, and the like.

FIGS. 1 and 2 respectively shows two stator assemblies 4 of prior art, which can be applied in an electric motorcycle. However, in the manufacturing process, a large central part of the stator core should be cut out and may become unavailable scrap metal.

Generally, in conventional electric motorcycles, most of the stator cores are designed to contain fifty-one or sixty-three slots and have to use neodymium-iron-boron (NdFeB) magnets, which are expensive, so as to achieve the purpose of a high-torque output. Since the number of the slots on the stator core 4 is a prime number, the stator core 4 is unable to be divided into multiple modules or blocks, each with the same dimension and number of slots, so as to reduce the manufacturing cost. Thus, there is a need for mitigating the disadvantage of the conventional stator cores.

Based on long-term experiences on the related works and constant efforts on the tests and modification of stator cores, the applicant has invent an improved structure for electric machines, whereby the stator core can be fabricated in a modularized way, so as to achieve the purpose of reducing the manufacturing cost.

### SUMMARY OF THE INVENTION

The primary object of the present invention is to provide an improved structure for electrical machines, to mitigate the disadvantage in that a large central part of the stator core thereof should be cut out and may become unavailable scrap metal, and to achieve the same power output as conventional structures that employ NdFeB magnets, by using the stator core thereof in cooperation with a rotor that employs iron-oxides magnets.

The secondary object of the present invention is to provide an improved structure for electrical machines, whereby the windings can be symmetrically mounted on the stator core with seventy-two slots, and the good rate of product can be increased.

To achieve the above purposes, the improved structure may comprise a plurality of stator modules, a supporting member, and at least one outer rotor. The stator modules are interconnected to form a stator core and define a total of seventy-two slots. The supporting member is fixedly mounted with the stator modules at a circumference thereof by means of a plurality of rivets or glue. The outer rotor is provided with a plurality of magnetic members for magnetically interaction with the stator modules. In particular, the number of the stator modules can be six, eight, or nine.

With the above structure, since the stator core thereof defines seventy-two slots, the stator core thereof can be divided into six, eight, or nine stator modules, each having the same dimension and slots, for ease of manufacturing; whereby, the disadvantage of having to cut out a large central part of a stator core, as in the conventional structures, can be overcome; moreover, the stator core thereof can cooperate with a rotor that employs iron-oxides magnets, to achieve the same power out as the conventional structures that employ expensive NdFeB magnets.

Other objects, advantages, and novel features of the present invention will become more apparent from the following detailed description when taken in conjunction with the accompanying drawings.

### BRIEF DESCRIPTION OF THE DRAWINGS

FIG. 1 shows a schematic view of a stator assembly of prior art.

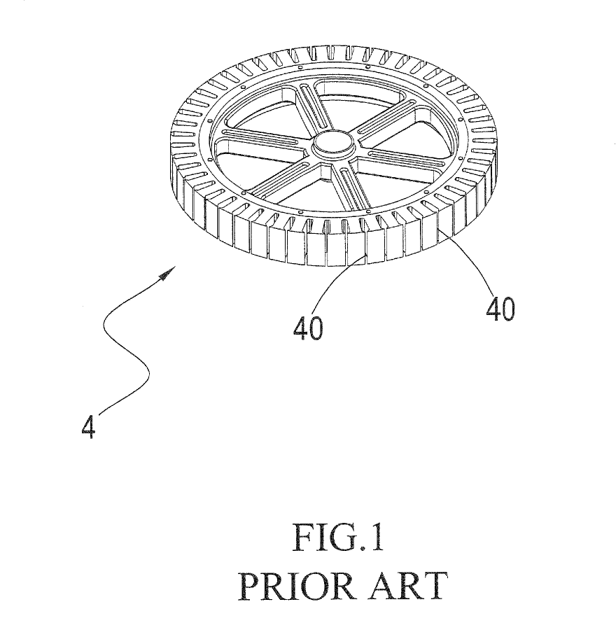

FIG. 2 shows a schematic view of another stator assembly of prior art.

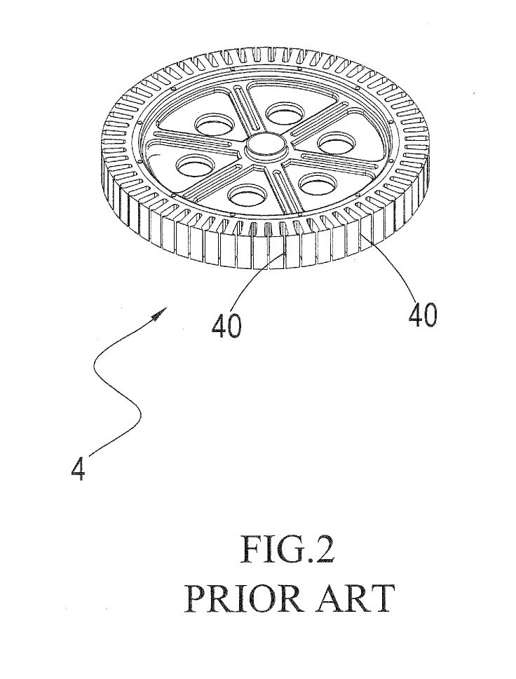

FIG. 3 shows a 3-dimensional view of an improved structure for electric machines according to a preferred embodiment of the present invention.

FIG. 4 shows an exploded view of the preferred embodiment.

FIG. 5 shows an exploded view of an outer rotor of the preferred embodiment.

FIG. 6 shows a stator module employed in the present invention.

FIG. 6A shows an exploded view of a stator assembly, which employs the stator module of FIG. 6

FIG. 6B shows an exploded view of an improved structure for electric machines according to the present invention, which employs the stator assembly of FIG. 6A.

FIG. 7 shows another stator module employed in the present invention.

FIG. 7A shows an exploded view of a stator assembly, which employs the stator module of FIG. 7

FIG. 7B shows an exploded view of an improved structure for electric machines according to the present invention, which employs the stator assembly of FIG. 7B.

FIG. 8 shows an exploded view of a stator assembly, which employs a further stator module.

### DETAILED DESCRIPTION OF THE PREFERRED EMBODIMENTS

A preferred embodiment of the present invention will be illustrated in the following to allow the features and functions of the present invention to be fully understood.

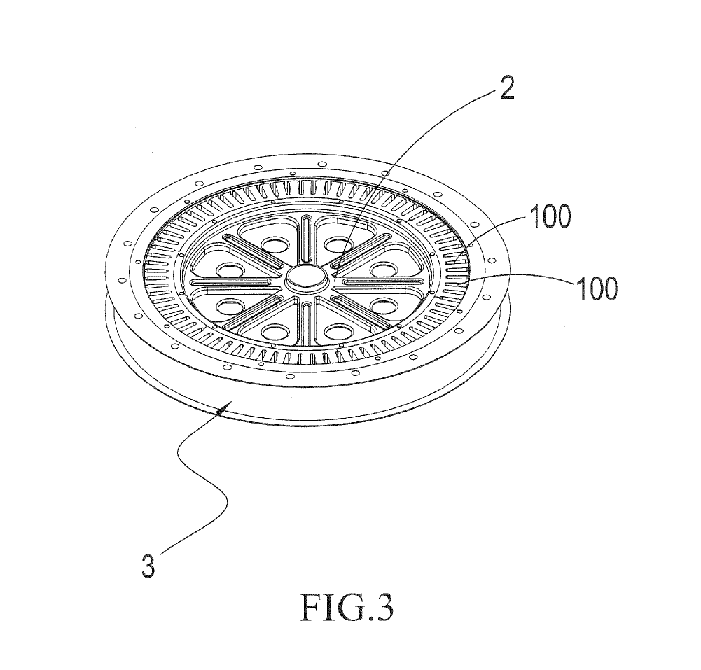

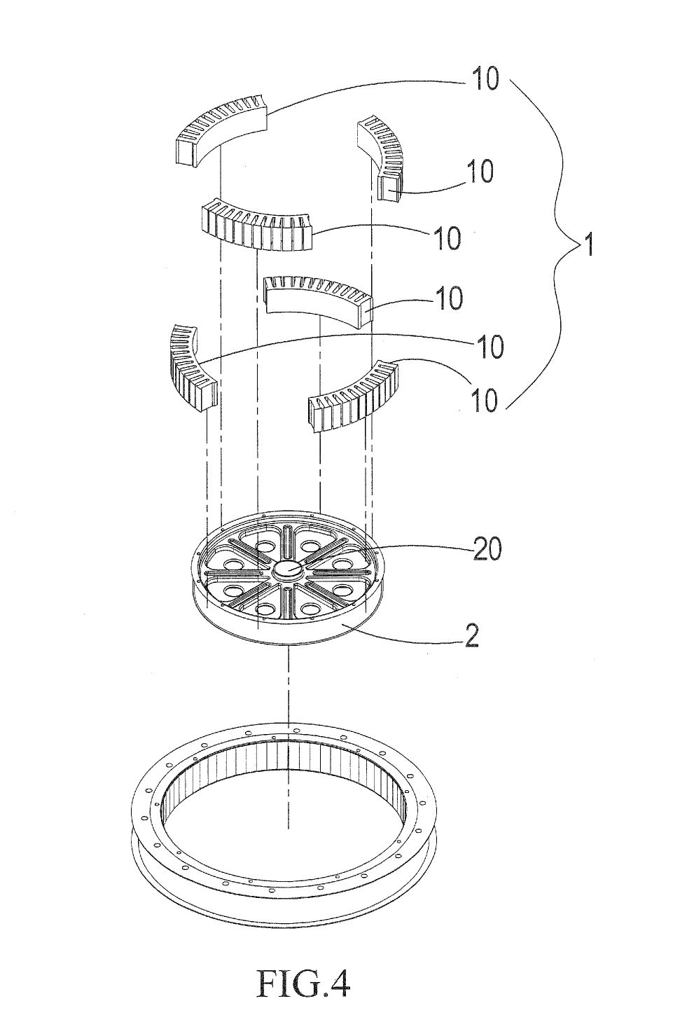

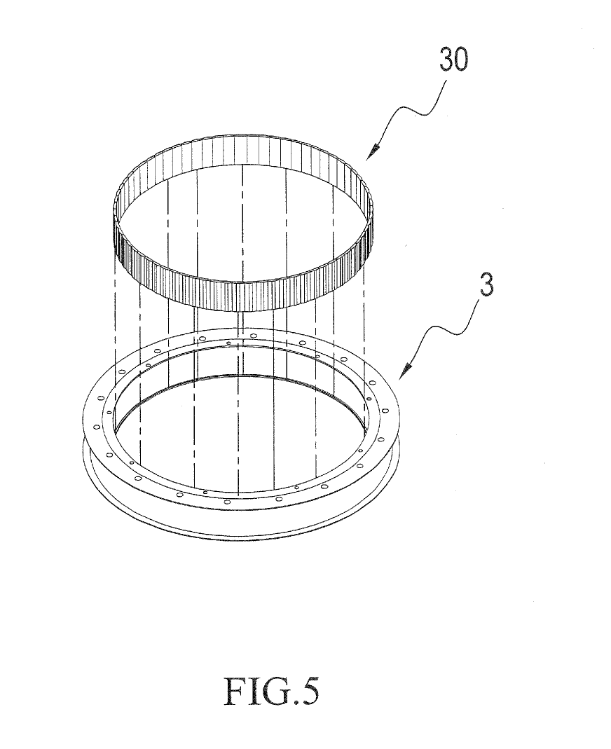

Referring to FIGS. 3, 4 and 5, an improved structure for electrical machines according to one embodiment of the present invention is disclosed, which generally comprises a plurality of stator modules 10, a supporting member 2, and at least one outer rotor 3. The stator modules 10 are interconnected and each defines a plurality of slots 100 on a surface thereof, wherein the stator modules 10 are interconnected to form a stator core 1, which has a total of seventy-two slots. The supporting member 2 is fixedly mounted with the stator modules 10 at a circumference thereof, and defines a shaft hole 20 at a center thereof. The outer rotor 3 is provided with a plurality of magnetic members 30, which can be magnets using iron oxides, for magnetically interaction with the stator modules 10.

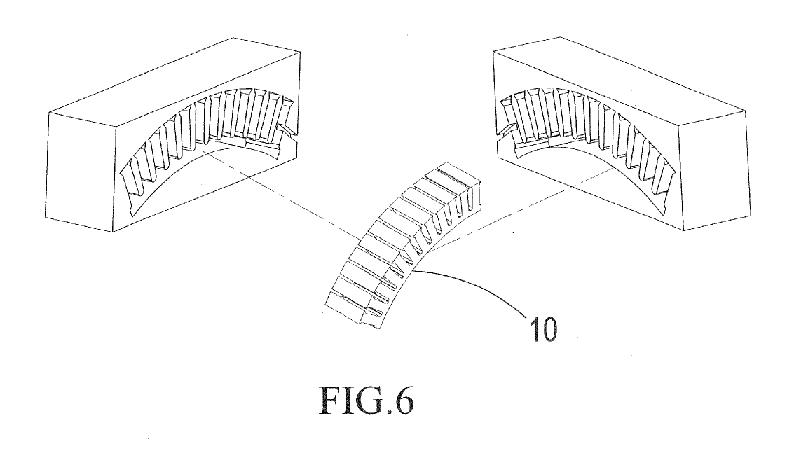

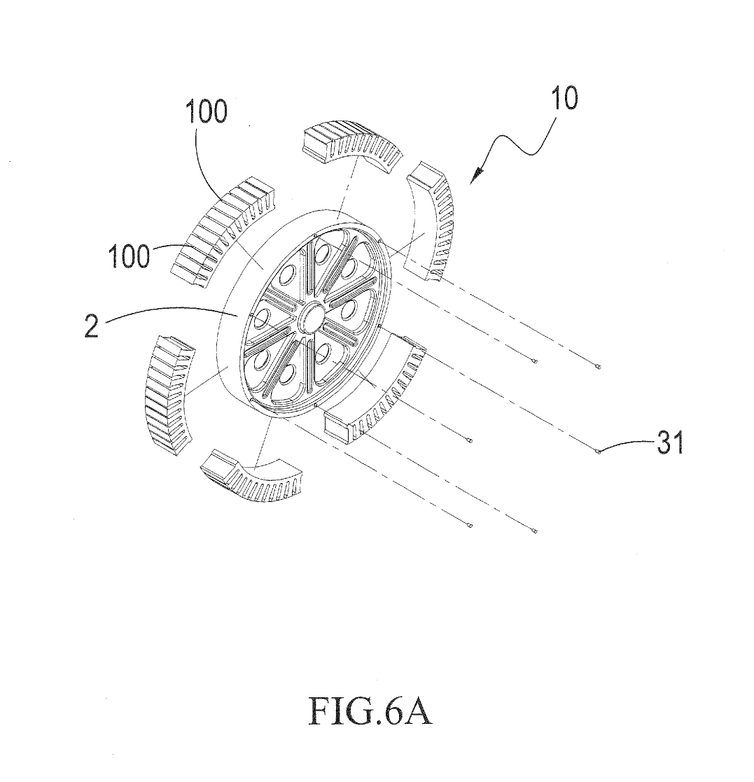

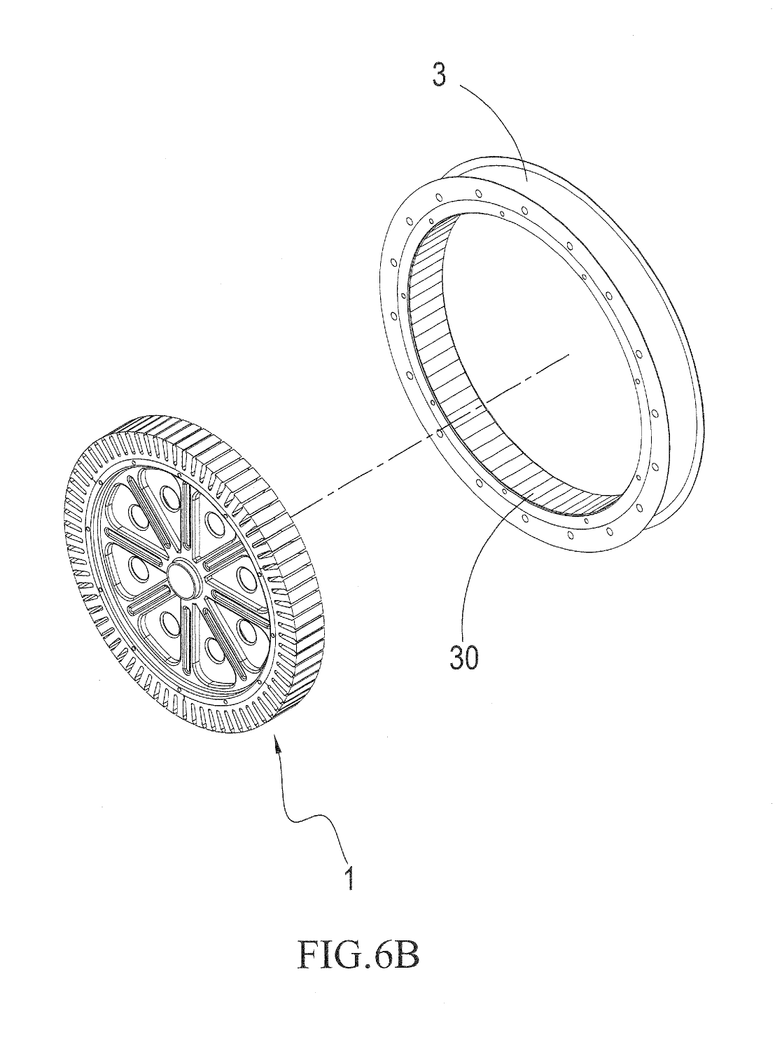

In implementing the present invention, as shown in FIGS. 6, 6A and 6B, the stator core 1 can be divided into six stator modules 100, each of which has the same dimension and number of slots 100; whereby, in the manufacturing process, they can be fixedly mounted onto the circumference of the supporting member 2 to form the stator core with a total of seventy-two slots. This design may mitigate the disadvantage in that a large central part of a stator core, as in the conventional structures, should be cut out and may become unavailable scrap metal. With this design, the scrap metal produced in the manufacturing can be greatly reduced, as compared with the design of the conventional stator cores. The six stator modules 10, each with twelve slots, can be fixedly mounted onto the circumference of the supporting member 2, by means of a plurality of rivets 31 or glue, to form an integral stator assembly. Accordingly, the integral stator assembly can be cooperated with the outer rotor 3, which is provided with multiple magnetic members 30, such as magnets using iron oxides, to achieve the same output as the conventional structures employing NdFeB magnets and defining either fifty-one or sixty-three slots, so that each stator module can be manufactured by a small mold in advance and then be assembled onto the supporting member 2, so that the manufacturing cost can be reduced.

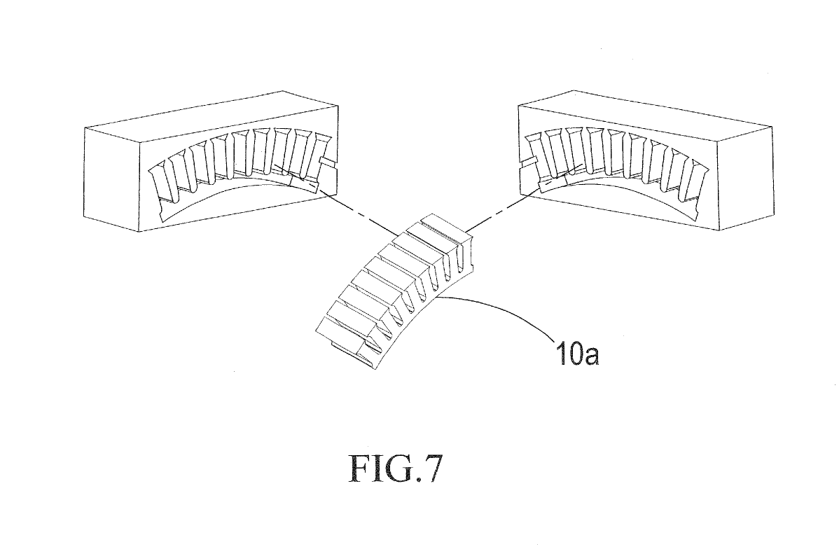

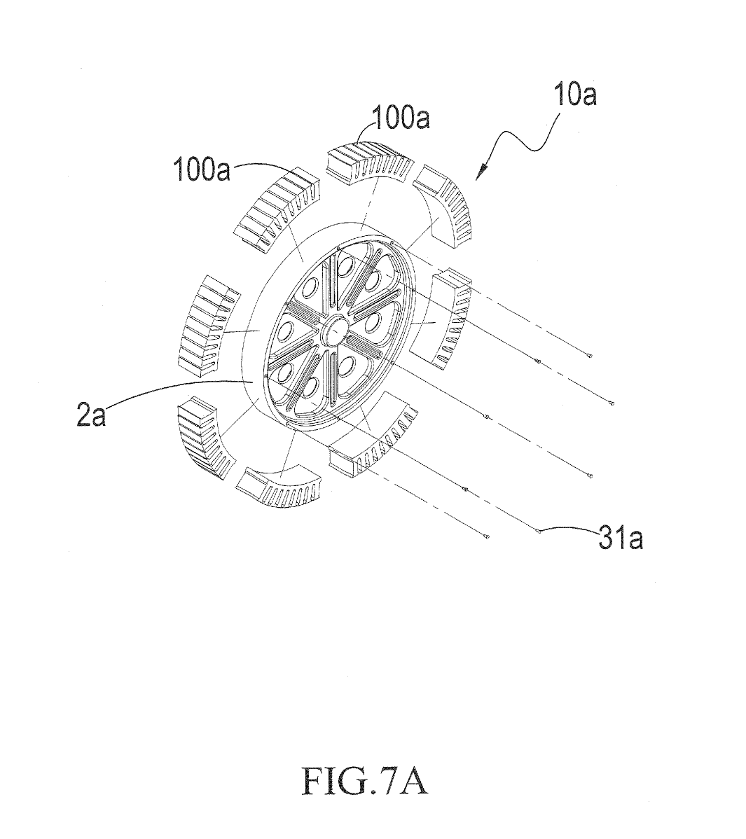

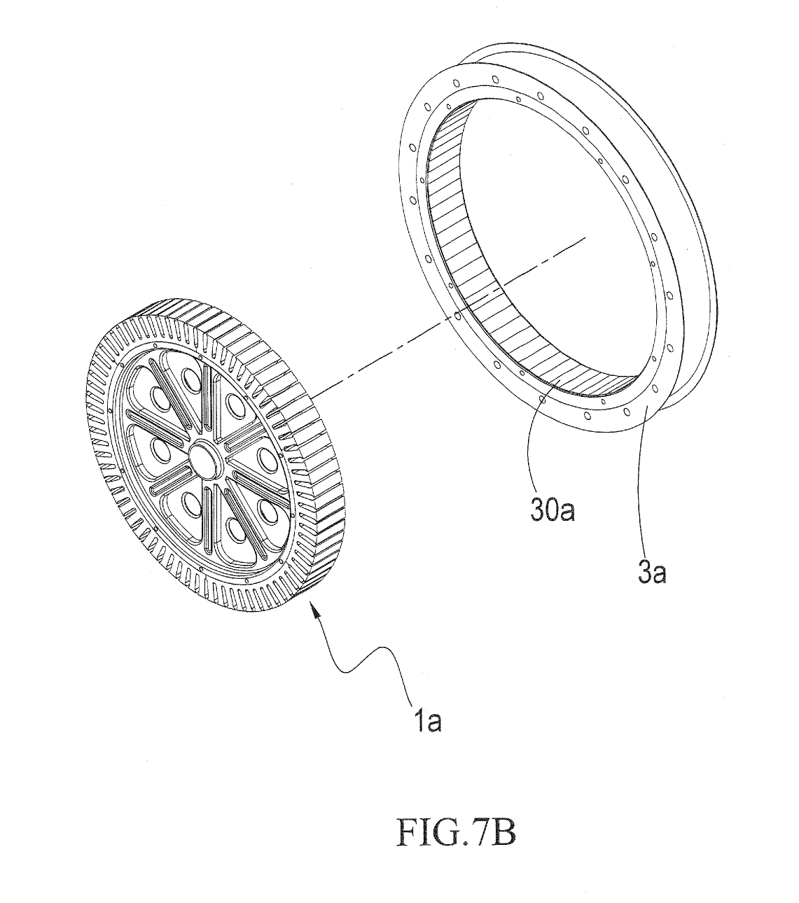

Tuning now to FIGS. 7, 7A and 7B, it is clearly shown that the stator core 1a is divided into eight stator modules 10a, each of which has the same dimension and number of slots 100a; whereby, in the manufacturing process, they can be fixedly mounted onto the circumference of the supporting member 2a to form the stator core with a total of seventy-two slots. This design may mitigate the disadvantage in that a large central part of a stator core, as in the conventional structures, should be cut out and may become unavailable scrap metal. With this design, the scrap metal produced in the manufacturing can be greatly reduced, as compared with the designs of conventional stator cores. The eight stator modules 10, each with nine slots, can be fixedly mounted onto the circumference of the supporting member 2a by means of a plurality of rivets 31a or glue to form an integral stator assembly. Accordingly, the integral stator assembly can be cooperated with the outer rotor 3a, which is provided with multiple magnetic member 30a, such as magnets using iron oxides, to achieve the same output as the conventional structures employing NdFeB magnets and defining either fifty-one or sixty-three slots, so that each stator module can be manufactured by a small mold in advance and then be assembled onto the supporting member 2, so that the manufacturing cost can be reduced.

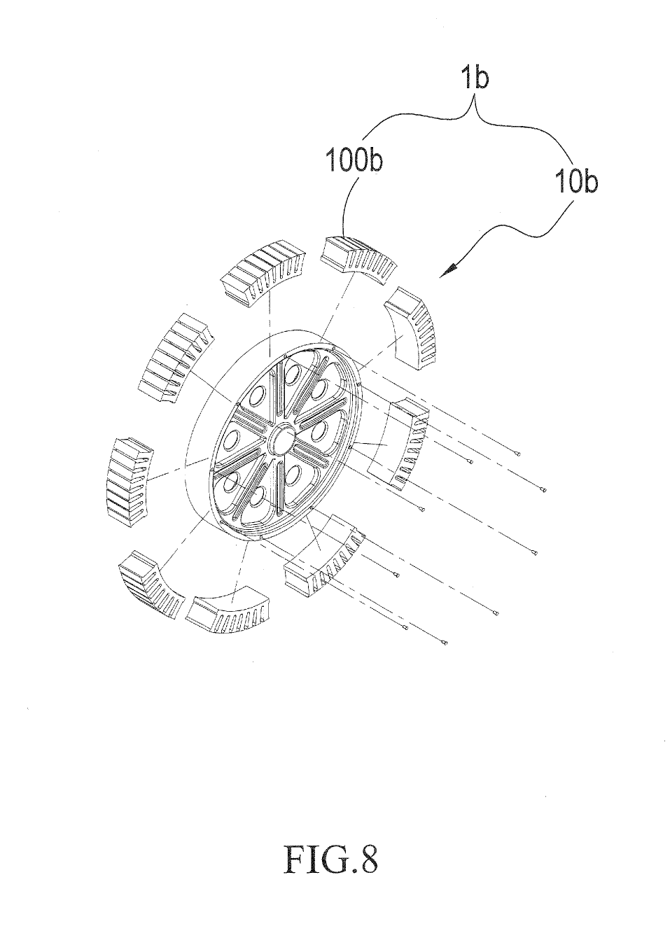

Tuning now to FIG. 8, it is clearly shown that the stator core 1b is divided into nine stator modules 10b, each of which has the same dimension and number of slots 100b; whereby, in the manufacturing process, they can be fixedly mounted onto the circumference of the supporting member to form the stator core with seventy-two slots. This design has the same functions and advantages as the previous situations. Thus, a further description for this situation is omitted here.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An improved structure for electrical machines, comprising:
a plurality of stator modules, which are interconnected and define a total of seventy-two slots;
a supporting member, which is fixedly mounted with said stator modules at a circumference thereof; and
at least one outer rotor, which is provided with a plurality of magnetic members for magnetically interaction with said stator modules.

2. An improved structure for electrical machines as claimed in claim 1, wherein said stator modules are fixedly mounted with said supporting member by means of a plurality of rivets.

3. An improved structure for electrical machines as claimed in claim 1, wherein said stator modules are fixedly mounted with said supporting member by means of glue.

4. An improved structure for electrical machines as claimed in claim 1, wherein the number of said stator modules is six.

5. An improved structure for electrical machines as claimed in claim 1, wherein the number of said stator modules is eight.

6. An improved structure for electrical machines as claimed in claim 1, wherein the number of said stator modules is nine.

7. An improved structure for electrical machines as claimed in claim 1, wherein said supporting member defines a shaft hole at a center thereof.

8. An improved structure for electrical machines as claimed in claim 1, wherein said magnetic members are magnets using iron oxides.
